(19) United States
(12) Patent Application Publication
(10) Pub. No.: US 2026/0348202 A1
(43) Pub. Date: Nov. 5, 2026

(54) SMART LATCH WITH INDUCTIVE SENSOR

(71) Applicant: MAGNA CLOSURES INC., Newmarket (CA)

(72) Inventors: Kar Wang WOO, Newmarket (CA); Ting Pong Earnest LOCK, Newmarket (CA); Cuong Trieu TRAN, Newmarket (CA)

(21) Appl. No.: 19/659,685

(22) Filed: Apr. 27, 2026

Related U.S. Application Data
(60) Provisional application No. 63/797,992, filed on May 1, 2025.

(51) Int. Cl. E05B 81/66; E05B 81/06; E05B 81/14; G01D 5/20

(52) U.S. Cl. CPC E05B 81/66; E05B 81/06; E05B 81/14; G01D 5/20

(57) ABSTRACT

A latch assembly for a closure of a vehicle includes a latch mechanism, a sensor monitor circuit, and a non-contact sensor. The latch mechanism has a plurality of latch components each being movable to define a plurality of operating positions of the latch mechanism. The non-contact sensor is configured to detect a position of at least one metal target. The sensor monitor circuit is in functional communication with the non-contact sensor and is configured to determine a position of at least one latch component based on the detected position of the at least one metal target.

### CROSS-REFERENCE TO RELATED APPLICATIONS

This application claims the benefit of U.S. Provisional Application No. 63/797,992, filed May 1, 2025. The entire disclosure of the above application is incorporated herein by reference.

### FIELD

The present disclosure relates generally to power closure systems for motor vehicles. More specifically, the present disclosure is directed to a latch assembly configured for installation in a door closure system with a sensor arrangement to detect positions of one or more components in the latch assembly.

### BACKGROUND

This section provides background information related to the present disclosure which is not necessarily prior art.

Door latch assemblies have typically many moving components. Traditionally, microswitches have been used to provide such position sensing of these components, where the component itself has an engagement profile to activate the microswitch at specific positions. Another common technology in automotive latch applications is the Hall-effect sensors, which uses magnets attached to each lever component. When the lever reaches a specific position beneath the Hall-effect sensors, it triggers a signal back to the BCM or a latch controller. However, microswitches and Hall-effect sensors each have drawbacks, such as cost, and weight. Microswitches have a limited operational lifespan and can cause other detrimental effects, such as noise, vibration, and harshness. Hall-effect sensors require expensive magnets to function.

In view of the above, there remains a need to develop improved sensing devices for latch assemblies to advance the art while providing increased applicability while reducing cost and complexity.

### SUMMARY

This section provides a general summary of the present disclosure and is not a comprehensive disclosure of its full scope or all of its features, aspects and/or objectives.

The present disclosure provides a latch assembly for a closure of a vehicle. The latch assembly includes: a latch mechanism having a plurality of latch components, a non-contact sensor configured to detect a position of at least one metal target, and a sensor monitor circuit in functional communication with the non-contact sensor. Each of the latch components is movable to define a plurality of operating positions of the latch mechanism. The sensor monitor circuit is configured to determine a position of at least one latch component of the plurality of latch components based on the detected position of the at least one metal target.

The present disclosure also provides a latch assembly for a closure of a vehicle and which includes: a latch mechanism having a plurality of latch components, and a sensor monitor circuit in functional communication with a non-contact sensor. The plurality of latch components are each movable to define a plurality of operating positions of the latch mechanism. The plurality of latch components includes a release lever having a body of metal. The non-contact sensor is configured to detect the body of the release lever within a given region adjacent to the non-contact sensor.

The present disclosure further provides a latch assembly for a closure of a vehicle, including a latch mechanism having at least one latch component each being movable to an operating position, a non-contact sensor arrangement configured to detect the presence of the at least one latch component relative to a given region adjacent thereto, and a sensor monitor circuit in functional communication with the non-contact sensor arrangement and configured to determine a position of the at least one latch component based on the detected presence.

In a related aspect, the non-contact sensor arrangement is configured to detect a metal portion of the at least one latch component.

In a related aspect, the at least one of latch component includes a body, and wherein the body is formed from metal to define the metal portion.

In a related aspect, the non-contact sensor arrangement is not configured to detect a magnet mounted on the at least one of latch component.

In a related aspect, the non-contact sensor arrangement comprises at least one non-contact sensor each configured to generate a field into the given region to detect the presence of the at least one latch component, wherein each non-contact sensor is configured to detect a disturbance of the field due to the at least one of latch component interacting with the field.

In a related aspect, the at least one non-contact sensor comprises a plurality of non-contact sensors in electrical communication with the sensor monitor circuit, wherein the plurality of non-contact sensors are coupled with each other in a sequence.

In a related aspect, one of the non-contact sensors defines a first non-contact sensor of the sequence and another one of the non-contact sensors defines a last non-contact sensor of the sequence.

In a related aspect, the sensor monitor circuit is adapted to apply an excitation signal to the sensor arrangement to cause each non-contact sensor to generate the field.

In a related aspect, each non-contact sensor comprises an input node and an output node, wherein at least one non-contact sensor has its input node that is coupled with the output node of another non-contact sensor, and wherein at least one non-contact sensor has its input node connected to the sensor monitor circuit to receive the excitation signal.

In a related aspect, the excitation signal is an alternating signal.

In a related aspect, the output node of the last non-contact sensor of the sequence is connected to a voltage bias.

In a related aspect, each non-contact sensor has a first coil configured to generate the field in response to receiving the excitation signal, wherein the non-contact sensor arrangement comprises a first circuit interconnecting a plurality of the first coils together in a series arrangement.

In a related aspect, each non-contact sensor has a second coil configured to generate a current in response to being subjected to the generated field that is modified by the at least one of latch component interacting with the generating field, wherein the non-contact sensor arrangement comprises a second circuit interconnecting a plurality of the second coils together in a series arrangement.

In a related aspect, the sensor monitor circuit is configured to detect a voltage level of the second circuit that is generated by the plurality of second coils to thereby distinguish between a plurality of different possible positions of the at least one latch component relative to the plurality of non-contact sensors.

In a related aspect, a printed circuit board is provided, wherein the sensor monitor circuit and the sensor arrangement are each disposed upon or formed within the printed circuit board.

In a related aspect, each non-contact sensor has a first coil configured to generate a field in response to receiving the excitation signal from the sensor monitor circuit, wherein the non-contact sensor arrangement comprises a first circuit interconnecting a plurality of the first coils together in a series arrangement, each non-contact sensor has a second coil configured to generate a current in response to being subjected to the generated field that is modified by the at least one of latch component interacting with the generated field, wherein the non-contact sensor arrangement comprises a second circuit interconnecting a plurality of the second coils together in a series arrangement, the printed circuit board includes a first side, and a second opposite side, wherein the first circuit is printed on the first side and the second circuit is printed on the second side.

In a related aspect, the printed circuit board extends in a plane overlying the plurality of latch components, and wherein the sensor monitor circuit includes one or more coils defined by a conductor within the plane of the printed circuit board.

In a related aspect, the plurality of latch components includes at least one of: a release lever, a pawl, a cinch lever, a ratchet, and a power release gear.

In a related aspect, the sensor monitor circuit is further configured to communicate, to a latch controller, a status of the latch assembly based on the determined position of the at least one latch component.

In a related aspect, the closure is a passenger door of the vehicle.

The present disclosure further provides a sensing configuration for a motor vehicle latch component having one or more moveable components each being movable to an operating position, the sensing configuration including a non-contact sensor arrangement configured to generate a field within a given region adjacent to the non-contact sensor to detect the presence of the at least one component in response to a disruption of the field by the at least one component interacting with the field, and a sensor monitor circuit in functional communication with the non-contact sensor arrangement and configured to determine a position of the at least one component based on the disruption of the field.

In a related aspect, the motor vehicle latch component having one or more moveable component may be a window regulator actuator, a power side door actuator, a remote cable cinch actuator, a remote cable power release actuator, a remote relay lock/unlock unit or brainplate, or a frunk latch, a liftgate latch, or a sliding door latch.

Further areas of applicability will become apparent from the description provided herein. The description and specific examples in this summary are intended for purposes of illustration only and are not intended to limit the scope of the present disclosure.

### DRAWINGS

The foregoing and other aspects of the present disclosure will now be described by way of example only with reference to the attached drawings, which:

FIG. 1 shows a plan view of a latch assembly of the present disclosure with a latch mechanism, a power-operated latch release mechanism, a cinching mechanism, and a reset mechanism;

FIG. 2 shows the latch assembly of FIG. 1 with position sensors of the sensing system arranged to detect positions of components therein; and

FIG. 3 shows a schematic block diagram of a sensing system for a latch assembly, in accordance with an aspect of the present disclosure.

### DETAILED DESCRIPTION

The present disclosure provides a technology for a side door latch of a motor vehicle. An aspect of the present disclosure provides for using inductive sensor design to detect the position of a latch or cinch mechanism in various stages of its travel and/or operating positions. Components shown include an inductive sensor design with multiple sensing points arranged on a printed circuit board (PCB), and a latch or cinch mechanism that can move between different positions like open, cinch start, cinch full travel, etc. The inductive sensor utilizes changes in PCB trace impedance caused by the proximity of metal components to detect the position of the latch. Multiple sensing points on the PCB are used to distinguish different latch positions by detecting unique impedance profiles corresponding to each position. The sensor design with the PCB layout has sensing trace patterns. The sensor design can detect different latch positions like open, cinch start, cinch full travel, etc. and maps them to the expected sensor readings at each position. Predetermined values are provided correlating the sensor signal values from points like CL 1, CL2, etc. to each latch position. This sensor data can be interpreted by a control system to determine the exact latch position for applications requiring precise latch travel monitoring. Overall, the inductive sensor approach aims to provide a robust, non-contact way to accurately track the position of a latch or cinch mechanism during operation for use in various industries.

The present disclosure uses alternative lever position sensing technology by using inductive sensor technology which employs a single inductive sensor chip instead of multiple Hall-effect sensors and magnets usage. Works with EE Smart Bridge. A single monitoring circuit may monitor the position status of all levers for the latch under various conditions. The present disclosure employs inductive sensor technology to address the problems outlined above, offering several advantages over traditional methods such as microswitches and Hall-effect sensors. Advantages provided by the systems and assemblies of the present disclosure include:
Simplified PCB Circuit Design: Inductive sensors simplify the latch PCB circuit design, creating a more straightforward solution. This simplification can potentially reduce the overall size of the PCB board, making the design more compact and efficient.
Cost Reduction: By integrating inductive sensor technology with a remote vehicle system architecture, such as Magna's Smart Bridge technology, the new inductive sensor arrangements of the present disclosure can help lower the cost of the latch. This reduction in latch cost translates to a decrease in the overall system cost, making it more economical for manufacturers and consumers. Elimination of a magnet from the sensing arrangement reduces costs.
Flex PCB Compatibility: Unlike standard PCBs, inductive sensors can potentially utilize flexible PCBs, which are generally lower in cost and can optimize the overall latch packaging. This flexibility in design allows for more innovative and space-saving configurations.
Versatility: Inductive sensor technology is not limited to door latch applications. It can also be applied to other door system related components that currently use microswitch designs, offering a broader range of applications and improvements across different latch and power actuator types.

Overall, the present disclosure provides a more efficient, cost-effective, and versatile solution for detecting the positions of release or lock chain lever components in side door latch applications, thereby enhancing the functionality and reliability of automotive door systems. The present disclosure provides applications of inductive sensor technology to address the problems outlined above, offering several key advantages over traditional methods such as microswitches and Hall-effect sensors.

The present disclosure addresses several issues in side door latch applications, enhancing both safety and functionality. Specifically, it provides status feedback to the vehicle's Body Control Module (BCM) or local latch controller for all release chain and lock chain components. This feedback allows the control system to understand the door status, including whether it is fully latched, locked, double locked, or in child lock mode for rear doors.

For more advanced side door latch applications, the present disclosure enables the control system to send signals to activate additional features such as power release, cinching, and ice-breaking functions. These features may be crucial for ensuring the latch control system accurately knows the latch status by monitoring the position of each release or locking lever component. This comprehensive feedback system significantly enhances the safety and convenience of the vehicle's door latch mechanism.

The present disclosure is not limited to side door latch application, it can be applied to other automotive latch product such as liftgate latch, seat latch, hood latch, frunk latch, tailgate latch and power door latching system application.

One aspect of the present disclosure is to enhance the accuracy, reliability, and efficiency of detecting the positions of all release or lock chain lever components in side door latch applications.

The present disclosure seeks to improve upon these methods and constructions by utilizing inductive sensor technology. This approach requires each lever to have a metal conductive point instead of a magnet. When the lever component reaches a specific position, the metal conductive point beneath the sensor coil triggers a voltage signal via an oscillator. The sensor then interprets this data and presents it to the control system, such as to a Smart Bridge as an Analog or SENT value. This method offers several advantages, including reduced complexity, enhanced durability, and improved signal accuracy, thereby achieving our objectives of advancing the detection technology for side door latch applications.

Example embodiments of a latch assembly for use in motor vehicle closure systems, constructed in accordance with the teachings of the present disclosure, will now be disclosed. The example embodiments of the latch assembly are further illustrated and described in association with a smart latch having integrated control electronics and optional backup energy sources. These example embodiments are provided so that this disclosure will be thorough, and will fully convey the scope to those who are skilled in the art. Numerous specific details are set forth such as examples of specific components, devices, configurations, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The present disclosure relates to motor vehicles including a passenger door pivotally mounted to a vehicle body via an upper door hinge and a lower door hinge. As will be detailed, door includes a latch assembly capable of releaseably latching a striker mounted on the vehicle body to hold the door in a closed position relative to vehicle body.

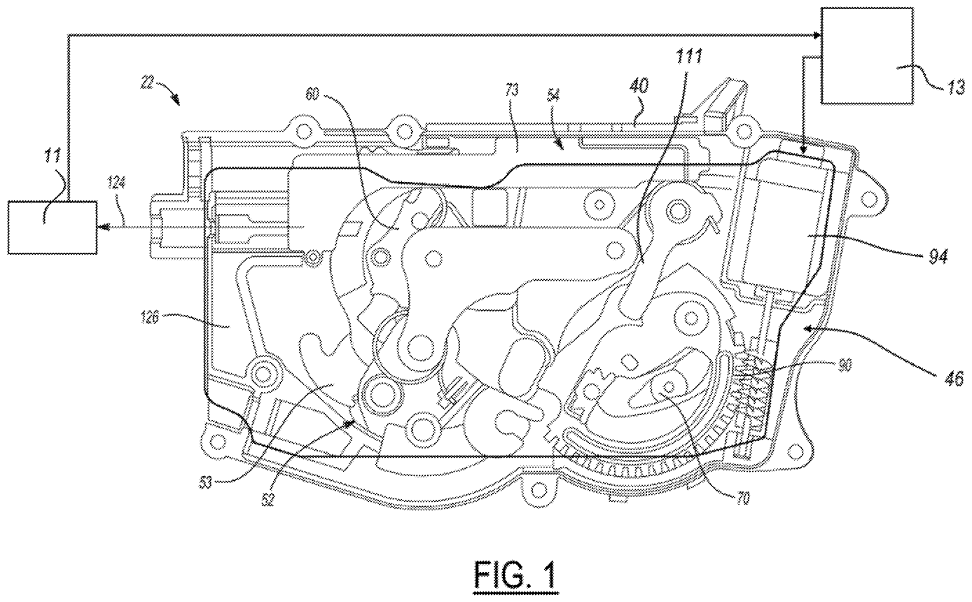

Referring now to FIG. 1, a first non-limiting example of a latch assembly 22 will be described to identify and define the disclosed concepts embodied therein. In general, the latch assembly 22 includes a latch housing 40, having a metal frameplate defining a fishmouth striker entry channel into which the striker can travel, a latch mechanism including a ratchet 60 for releasably engaging with the striker and a pawl 70 for releasably engaging with the ratchet 60.

The latch assembly 22 includes a power-operated latch release mechanism 46 having a power release motor 94 for rotating a power release gear 90, such that the rotation of the power release gear 90 can act on the pawl 70 to cause the pawl 70 to disengage from the ratchet 60 to thereby release the striker and allow the door to move away from the closed position. Power release motor 94 is shown as electrically connected to a latch controller 13, which may include power electronics and a microprocessor with associated memory for controlling operation of the power release motor 94. An exemplary power release configuration of latch assembly 22 as well as other aspects are shown and described in co-owned U.S. Pat. No. 11,072,948 titled “Smart latch”, the entire contents of which are incorporated herein by reference.

Latch assembly 22 may be configured as a “Smart Latch” having integrated control and power electronics, with or without a backup energy source, as well as other aspects, are shown in described in co-owned U.S. Pat. No. 9,353,556 titled “Electrical vehicle latch”, the entire contents of which are incorporated herein by reference.

The latch assembly 22 may also optionally include a power-operated cinch mechanism 52 configured to move the ratchet 60 towards a position where the pawl 70 can engage with the ratchet 70 to hold the door in the closed position. The power cinch mechanism 52 is operable to rotate the ratchet 60 to its fully cinched primary striker capture position from a secondary striker capture position. The power cinch mechanism 52 may include a power cinch actuator and a cinch lever 53 converting the output of the cinch actuator into rotation of the ratchet 60 in the latching direction. Power cinch actuator may include a power cinch motor controlled by the latch controller 13. Latch assembly 22 may be configured having cinching functionality as well as having other aspects as shown in described in co-owned U.S. Pat. No. 10,767,397 titled “Single motor latch assembly with power cinch and power release having soft opening function”, the entire contents of which are incorporated herein by reference.

The latch assembly 22 may also optionally include an inside/outside (IS/OS) latch release mechanism 54 that includes a release lever 73 that is operationally coupled to an inside/outside (IS/OS) handle 11 via a Bowden cable such that actuation of the inside/outside handle 11 to move the pawl 70 imparts a pulling force 124 on the Bowden cable. Latch handles 11 may include microswitches to detect motion of the inside/outside handle, where the microswitches are electrically connected to the latch controller 11 to trigger the control of the power release motor 94.

The latch assembly 22 may also include a reset mechanism that is generally shown to include a biased reset lever 111 mounted via a backdrive lever pivot post to latch housing 40 to apply a resetting force to the power release gear 90 and return the power release gear 90 to a home position after the electric motor 94 has been deactivated following a power release operation. Latch assembly 22 may be configured having at least a reset mechanism as well as having other aspects as shown in described in co-owned U.S. Pat. No. 11,072,948 titled “Smart Latch”, the entire contents of which are incorporated herein by reference.

Construction of the latch assembly 22 may use aspects of latch assemblies described which are hereby incorporated by reference in their entireties.

The various components of the latch assembly 22, such as the pawl 70, the ratchet 60, the release lever 73, the power release gear 90, the reset lever 111, and the cinch lever 53 may be constructed from metal to provide a metal target, and optionally may be encapsulated with a plastic casing to enclose the metal. Optionally, the metal of the latch components may be fully exposed. Optionally, the metal of the latch components may be partially exposed. Optionally, the components of the latch assembly 22 may be plastic having a metal object secured within the plastic. The metallic latch components may not have a magnetized state, and may not be provided with a magnet outputting a magnetic field.

The latch assembly 22 also includes a supporting substrate 126, such as a printed circuit board (PCB) that overlies the various latch components 53, 60, 70, 73, 90, and which is configured to support sensors which sense positions of those components to determine a condition of the latch assembly 22. Illustratively, printed circuit board 126 is disposed in a plane above the plane of the various latch components 53, 60, 70, 73, 90. Substrate 126, or printed circuit board, may have a first side, and an opposite second side.

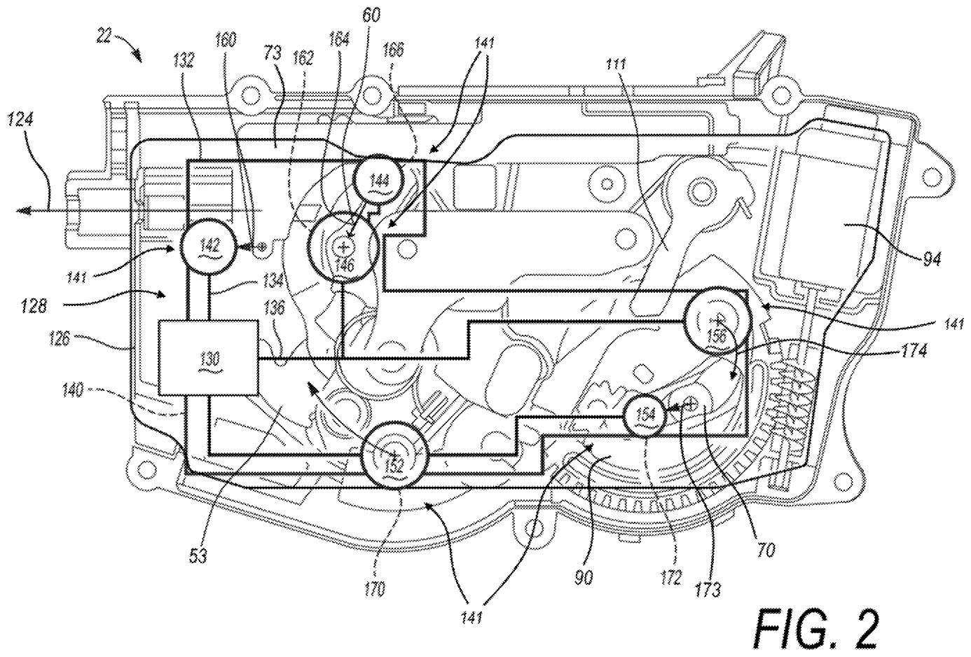

Now referring to FIG. 2, supporting substrate 126 is shown to include one or more sensors 141. The one or more sensors 141 are illustratively configured as non-contact sensors configured to detect a position of at least one target, which may be a metal target associated with the various latch components 53, 60, 70, 73, 90. For example, the metal target may be a metal portion of the various latch components 53, 60, 70, 73, 90, which may include part of a metal body of the various latch components 53, 60, 70, 73, 90, or a separate metal portion mounted to the various latch components 53, 60, 70, 73, 90, such as through overmolding, snap fitting, or other connection methods. For example, the various latch components 53, 60, 70, 73, 90 may have a plastic body with a metal element secured therein during the molding process, or adhered to using adhesive, or connected to via a press fit connection. The metal portion of the various latch components 53, 60, 70, 73, 90 may be non-magnetic field generating, meaning that the metal portion does not inherently generate a magnetic field, as known hall sensor magnets require. Therefore, the various latch components 53, 60, 70, 73, 90 are not provided with a magnet acting as a target for the one or more sensors 141, as is current with known hall sensor arrangements.

In one possible embodiment, the one or more sensors 141 are inductive sensors. Inductive sensors are of the type electronic device that functions using the principle of electromagnetic induction to detect or measure nearby metallic objects. An inductor generates a magnetic field when an electric current flows through it the propagates within and around the sensor; alternatively, a current will flow through a circuit containing an inductor when the magnetic field through it changes. This magnetic field may be internally or externally originating. This effect can be used to detect metallic objects that interact with a magnetic field. Such interaction my cause a disruption when a metallic object, such as provided by the possible described constructions of the various latch components 53, 60, 70, 73, 90, move through the field generated by the induction sensor in a region adjacent to the one or more sensors 141. The field generated by the inductive sensors may be a magnetic or electromagnetic field.

The one or more sensors 141 include induction sensors that are each associated with one of the various latch components 53, 60, 70, 73, 90. In another possible configuration, two or more sensors 141 may be associated with a single latch component. In another possible configuration, a single sensor 141 may be associated with two or more various latch components.

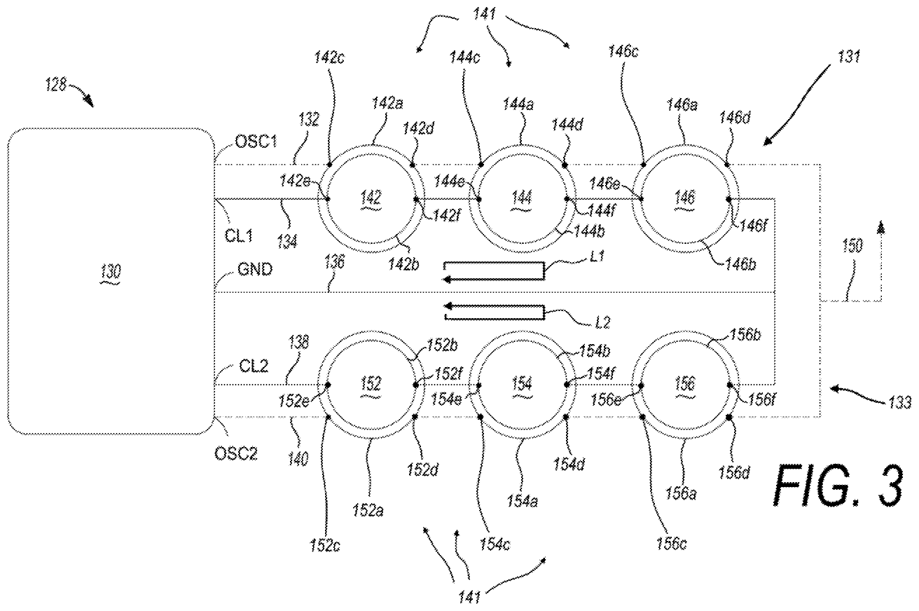

Now referring to FIG. 3, the inductive position sensors 142, 144, 146, 152, 154, 156 are arranged to detect positions of latch components 53, 60, 70, 73, 90. The position of the latch components 53, 60, 70, 73, 90 may be detected by sensing a change in the magnetic field of the inductive position sensors 142, 144, 146, 152, 154, 156 as the various latch components 53, 60, 70, 73, 90 enters into, and/or travels through, and/or travels out of the magnetic field, and/or remains in the magnetic field. In other words, movement of the various latch components 53, 60, 70, 73, 90 between, to, or from an operating position will modify the generated field.

Illustratively, the first inductive position sensor 142 is configured to detect presence of the release lever 73 adjacent thereto, as indicated by arrow 160 as the release lever 73 moves as part of an actuation motion (e.g. cause by a pull of the Bowden cable 124) between operating positions from a non-releasing position (outside the detection range of the first inductive position sensor 142) to a releasing position (inside a detection range of the first induction position sensor 142).

The second inductive position sensor 144 and the third inductive position sensor 146 may each be used to detect the operating positions of the ratchet 60 between open, closed, and secondary positions, as indicated by the circled areas 162, 166 and the arrow 164 therebetween. For example, the second induction sensor 144 may be used to detect the ratchet 60 in the closed position when the ratchet 60 is within a sensing range of the second induction sensor 144. When neither the second induction sensor 144 or the third inductive sensor 146 detect the ratchet 60 then control logic associated with the sensors can determine that the ratchet 60 is in a secondary position, outside the sensors ranges of both the second induction sensor 144 and the third inductive position sensor 146. When the third induction sensor 146 detects the ratchet 60 when the ratchet 60 is within a sensing range of the third induction sensor 146, the operating position of the ratchet 60 in the open position can be determined.

The fourth inductive position sensor 152 may detect the cinch lever 53 in a home operating position, as indicated by the circled area 170 which may also indicate to control logic that the ratchet 60 has been moved to a secondary operating position so as a trigger a commencement of a cinch operation to move the ratchet 60 from the secondary striker capture position towards the primary striker capture position during actuation movement of the cinch lever 53 between operating positions.

The fifth inductive position sensor 154 may detect the pawl 70 in a rachet-holding position, as indicated by the circle 172 when the pawl 70 is with the detection range of the fifth inductive position sensor 154. When the fifth inductive position sensor 154 does not detect the position of the pawl 70 having moved in a releasing direction indicated by arrow 173 to a releasing operating position, the control logic can deduce that the pawl 70 is being successfully moved by the power release gear 90 to release the ratchet 60 from engagement with the pawl 70.

The sixth inductive position sensor 156 may detect the PR gear 90 in a full-release position as indicated by arrow 174 after having moved from a home operating position to outside a detection range of the sixth inductive position sensor 156.

However, these are merely examples, and any or all of the inductive position sensors 142, 144, 146, 152, 154, 156 may have a different location to detect one or more different components of the latch assembly 22 and/or different positions of the latch components 53, 60, 70, 73, 90 moving into or out of detection range of the inductive position sensors 142, 144, 146, 152, 154, 156 described and shown in the present disclosure. The one or more sensors 141 may sense a disruption or change in the magnetic field outputted by the one or more sensors 141 which is due to the effect of the metal components associated with the latch components 53, 60, 70, 73, 90 on the magnetic field of an associated sensor 141. Illustratively, the portion of the latch components 53, 60, 70, 73, 90 that influence the magnetic field generated by the sensors 141 are shown using a “+” symbol, but the portion may be larger or smaller than that portion marked using the “+” symbol. The effect of the metal component may be due to the metal component entering into the magnetic field, moving out of the magnetic field, or changing the magnetic field as the metal component moves within the magnetic field. The control logic associated with the one or more sensors 141 may be adapted to determine changes in the magnetic field by the latch components 53, 60, 70, 73, 90 interacting with the magnetic field. For example, as the latch components 53, 60, 70, 73, 90 enters into, moves through and/or leaves the generated field of the one or more sensors 141, the one or more sensors 141 may detect a disturbance of the generated field.

Referring now to FIG. 3 shows a schematic block diagram of a sensing system 128 for detecting positions of components in a latch assembly 22. The sensing system 128 includes a plurality of electrical or electronic components that may be attached to or integrated within the PCB 126 for sensing positions of the latch components 53, 60, 70, 73, 90. The sensing system 128 includes a sensor monitor circuit 130, which may include one or more integrated circuits for interfacing to and managing of inductive position sensors. The sensing system 128 may be part of the latch controller 13, or separate therefrom. The sensor monitor circuit 130 may include, for example, an LX34312 device from Microchip Technology. However, other devices may be used. The sensor monitor circuit 130 defines a ground terminal GND, a first oscillator output terminal OSC1, a second oscillator output terminal OSC2, a first input terminal CL1, and a second input terminal CL2 for connection with the inductive position sensors 142, 144, 146, 152, 154, 156. The sensor monitor circuit 130 may be connected with the inductive position sensors 142, 144, 146, 152, 154, 156 that are arranged together in a sequence. Illustratively, the sequence of arrangement of the inductive position sensors 142, 144, 146, 152, 154, 156 is shown in a series arrangement distributed in two loops L1, L2. As illustrated, first inductive position sensor 142, second inductive position sensor 144, and third inductive position sensor 146 are in series connection with each other forming loop L1. Fourth inductive position sensor 152, fifth inductive position sensor 154, and sixth inductive position sensor 156 are in series connection with each other forming loop L2. First induction position sensor 142 is connected to OSC1 and CL1, and third induction position sensor 146 is connected to GND. Fourth induction position sensor 152 is connected to OSC2 and CL2, and sixth inductive position sensor 156 is connect to GND.

Other types of arrangements such as in a parallel arrangement, or a combination of parallel and series arrangement may be provided. In some embodiments, the sensor monitor circuit 130 may be configured to determine the positions of the latch components 53, 60, 70, 73, 90 by distinguishing between multiple discrete detected operating positions based on the presence or absence of metal targets within corresponding detection regions.

The sensing system 128 also includes a first inductive position sensor 142, a second inductive position sensor 144, a third inductive position sensor 146, a fourth inductive position sensor 152, a fifth inductive position sensor 154, and a sixth inductive position sensor 156.

Each of the inductive position sensors 142, 144, 146, 152, 154, 156 may include two or more coils which may be implemented using conductive traces of the PCB 126. Each of the inductive position sensors 142, 144, 146, 152, 154, 156 may output a sensor signal into the plane of motion of the latch components 53, 60, 70, 73, 90. Illustratively, the inductive position sensors 142, 144, 146, 152, 154, 156 are configured to generate a magnetic field as sensor signal that is outputted, whereby the magnetic field of the inductive position sensors 142, 144, 146, 152, 154, 156 is changed by the metal of the latch components 53, 60, 70, 73, 90 interacting with the magnetic fields.

Each of the inductive position sensors 142, 144, 146, 152, 154, 156 may include a each transmitting coil 142a, 144a, 146a, 152a, 154a, 156a and/or a receiving coil 142b, 144b, 146b, 152b, 154b, 156b. Transmitting coils 142a, 144a, 146a, of the first inductive position sensor 142, the second inductive position sensor 144, and the third inductive position sensor 146 are each connected in series between the first oscillator output terminal OSC1 of the sensor monitor circuit 130 and a power terminal 150 via a first transmitting conductor 132. An biasing voltage Vin may be applied to the power terminal 150 by a power source (not shown). Receiving coils 142b, 144b, 146b of the first inductive position sensor 142, the second inductive position sensor 144, and the third inductive position sensor 146 are each connected in series between a ground conductor 136 connected to the ground terminal GND and the first input terminal CL1 of the sensor monitor circuit 130 via a first receiving conductor 134. Sensor monitor circuit 130 maybe configured to generate an excitation signal at the first oscillator output terminal OSC1. In a possible configuration, excitation signal may be an alternating signal, and may be specifically an alternating current signal.

Transmitting coils 152a, 154a, 156a of the fourth inductive position sensor 152, the fifth inductive position sensor 154, and the sixth inductive position sensor 156 are each connected in series between the second oscillator output terminal OSC2 of the sensor monitor circuit 130 and the power terminal 150 via a second transmitting conductor 140. Receiving coils 152b, 154b, 156b of the fourth inductive position sensor 152, the fifth inductive position sensor 154, and the sixth inductive position sensor 156 are each connected in series between the ground conductor 136 and the second input terminal CL2 of the sensor monitor circuit 130 via a second receiving conductor 138.

The receiving coils 142b, 144b, 146b, 152b, 154b, 156b are configured to sense a change in the generated magnetic field using for example magnetic induction whereby the current-carrying conductors of the receiving coils 142b, 144b, 146b, 152b, 154b, 156b develop a current induced in them when subjected to a changing magnetic field (for example which may be caused by a metal portion of the latch component 53, 60, 70, 73, 90 moving through which can be detected by the sensor monitor circuit 130 via the CL1, CL2 input terminals.

As shown in FIG. 3, the inductive position sensors 142, 144, 146, 152, 154, 156 are connected together in a sequence. The illustrated sequence may include sensor 142 as the first sensor, sensor 144 as a next sensor, and sensor 146 as the last sensor in the sequence. Each transmitting coil 142a, 144a, 146a, 152a, 154a, 156a of the respective inductive position sensors 142, 144, 146, 152, 154, 156 includes an input node 142c, 144c, 146c, 152c, 154c, 156c and an output node 142d, 144d, 146d, 152d, 154d, 156d that are connected together through the current carrying conductor of the coil (e.g. input node 142c is connected to line 132, input node 144c is connected to output node 142d, input node 146c is connected to output node 144d, input node 152c is connected to line 140, input node 154c is connected to output node 152d, input node 156c is connected to output node 154d, and output nodes 146d, 156d are connected to common power terminal 150. Input node 142c of the first sensor 142 is connected to the sensor monitor circuit 130 to receive the excitation signal of the first oscillator output terminal OSC1.

The series connections of the output nodes 142d, 144d, 146d, 152d, 154d, or a preceding sensor 141 in the sequence with the respective input nodes 144c, 146c, 152c, 154c, 156c of the next sensor 141 in the sequence will cause the excitation signal to be transmitted to each transmitting coil 142a, 144a, 146a, 152a, 154a, 156a. The excitation signal travelling through each transmitting coil 142a, 144a, 146a, 152a, 154a, 156a will in response response cause the generation of the field adjacent to the respective transmitting coil 142a, 144a, 146a, 152a, 154a, 156a. The output node 146c, 156c of the last inductive position sensors 146, 156 in the sequence is connected to a voltage bias. Voltage bias is provided by connection to power terminal 150, but it is understood voltage bias could be provided by connection to a ground terminal. The illustrative connection of the transmitting coil 142a, 144a, 146a, 152a, 154a, 156a together form a first circuit 131. Transmitting coils 142a, 144a, 146a, 152a, 154a, 156a and any interconnecting traces between transmitting coil 142a, 144a, 146a, 152a, 154a, 156a may be printed onto the PCB 126 to form the first circuit 131. First circuit 131 may be provided on the first side of the PCB 126.

Similarly, each receiving coil 142b, 144b, 146b, 152b, 154b, 156b of the respective inductive position sensors 142, 144, 146, 152, 154, 156 includes an input node 142e, 144e, 146e, 152e, 154e, 156e and an output node 142f, 144f, 146f, 152f, 154f, 156f that are connected together through the current carrying conductor of the coil. Input node 142e of the first sensor 142 is connected to the first input terminal CL1. The series connections of the output node 142g, 144g, 146g, 152g, 154g, or a preceding sensor 141 in the sequence with the input node 144f, 146f, 152f, 154f, 156f of the next sensor 141 in the sequence will cause the induced currents (via a varied magnetic field cause by the metal portion interacting with the generated magnetic field) in the receiving coil 142b, 144b, 146b, 152b, 154b, 156b to cumulatively combine, such that a voltage level at the first input terminal CL1 and second input terminal CL2 will be detected. The output nodes 146f, 156f of the last inductive position sensors 146, 156 in the sequence is connected to a voltage bias. Voltage bias is provided by connection to ground terminal 136, but it is understood voltage bias could rather be provided by connection to a powered terminal. The illustrative connection of the receiving coil 142b, 144b, 146b, 152b, 154b, 156b together form a second circuit 132. Receiving coils 142b, 144b, 146b, 152b, 154b, 156b and any interconnecting traces between receiving coils 142b, 144b, 146b, 152b, 154b, 156b may be printed onto the PCB 126 to form the second circuit 132. Second circuit 132 may be provided on the second side of the PCB 126.

With the latch assembly 22 in an open position, the sensor monitor circuit 130 may determine the positions of the latch components 53, 60, 70, 73, 90 by detecting voltages as sensor data on the first input terminal CL1 and the second input terminal CL2, as set forth in the following tables, where 0 represents a target not present, a 1 represents a target being present within a given region adjacent to or otherwise associated with a corresponding one of the inductive position sensors 142, 144, 146, 152, 154, 156.

TABLE 1
CL1

| Pos. 3 | Pos. 2 | Pos. 1 | CL1 |
|---|---|---|---|
| (146) | (144) | (142) | (V) |
| 0 | 0 | 0 | 0.0 |
| 0 | 0 | 1 | 0.25 |
| 0 | 1 | 0 | 0.5 |
| 0 | 1 | 1 | 0.75 |
| 1 | 0 | 0 | 1.0 |
| 1 | 0 | 1 | 1.25 |
| 1 | 1 | 0 | 1.5 |
| 1 | 1 | 1 | 1.75 |

TABLE 2
CL2

| Pos. 6 | Pos. 5 | Pos. 4 | CL2 |
|---|---|---|---|
| (156) | (154) | (152 | (V) |
| 0 | 0 | 0 | 0.0 |
| 0 | 0 | 1 | −0.25 |
| 0 | 1 | 0 | −0.5 |
| 0 | 1 | 1 | −0.75 |
| 1 | 0 | 0 | −1.0 |
| 1 | 0 | 1 | −1.25 |
| 1 | 1 | 0 | −1.5 |
| 1 | 1 | 1 | −1.75 |

When the latch assembly 22 is in an open position, each of the third inductive position sensor 146, the fourth inductive position sensor 152, and the sixth inductive position sensor 156 may be activated by corresponding ones of the latch components 53, 60, 70, 73, 90 adjacent thereto. This particular arrangement of components may be sensed by the sensor monitor circuit 130 as voltages of 1.0V and −1.25 V on the first input terminal CL1 and the second input terminal CL2, respectively. The different detected voltage levels may be used by the sensor monitor circuit 130 to distinguish between a plurality of different possible positions of the plurality of latch components 53, 60, 70, 73, 90 relative to the plurality of non-contact sensors 142, 144, 146, 152, 154, 156.

When the latch assembly 22 is in a secondary position, each of the fourth inductive position sensor 152, the fifth inductive position sensor 154, and the sixth inductive position sensor 156 may be activated by corresponding ones of the latch components 53, 60, 70, 73, 90 adjacent thereto. This particular arrangement of components may be sensed by the sensor monitor circuit 130 as voltages of 0.0V and −1.25 V on the first input terminal CL1 and the second input terminal CL2, respectively.

When the latch assembly 22 is between the secondary position and a cinch start position, each of the fifth inductive position sensor 154, and the sixth inductive position sensor 156 may be activated by corresponding ones of the latch components 53, 60, 70, 73, 90 adjacent thereto. This particular arrangement of components may be sensed by the sensor monitor circuit 130 as voltages of 0.0V and −1.5 V on the first input terminal CL1 and the second input terminal CL2, respectively.

When the latch assembly 22 is between the primary position and a cinch full travel position, each of the second inductive position sensor 144, the fifth inductive position sensor 154, and the sixth inductive position sensor 156 may be activated by corresponding ones of the latch components 53, 60, 70, 73, 90 adjacent thereto. This particular arrangement of components may be sensed by the sensor monitor circuit 130 as voltages of 0.5V and −1.5 V on the first input terminal CL1 and the second input terminal CL2, respectively.

When the latch assembly 22 is between the primary position and a power release position, each of the first inductive position sensor 142, the second inductive position sensor 144, the fourth inductive position sensor 152, the fifth inductive position sensor 154, and the sixth inductive position sensor 156 may be activated by corresponding ones of the latch components 53, 60, 70, 73, 90 adjacent thereto. This particular arrangement of components may be sensed by the sensor monitor circuit 130 as voltages of 0.75V and −1.75 V on the first input terminal CL1 and the second input terminal CL2, respectively.

When the latch assembly 22 is between the open position and a power release full travel position, each of the first inductive position sensor 142, the second inductive position sensor 144, and the fourth inductive position sensor 152 may be activated by corresponding ones of the latch components 53, 60, 70, 73, 90 adjacent thereto. This particular arrangement of components may be sensed by the sensor monitor circuit 130 as voltages of 0.75V and −0.25 V on the first input terminal CL1 and the second input terminal CL2, respectively. The voltages first input terminal CL1 and the second input terminal CL2 may be a sum of the individual voltage drops across plurality of non-contact sensors 142, 144, 146 of loop L1 and of plurality of non-contact sensors 152, 154, 156 of loop L2. Current induced in each of the coils of the sensors 142, 144, 146, 152, 154, 156 may cause the detectable voltage drop across the resistance provided by the current flowing through the coils.

The polarity and magnitude of the detected voltage may depend on circuit orientation and biasing, and the illustrated values are exemplary.

A control system, such as latch controller 13, may receive this sensor data and can interpret the sensor data, for example through use of the look up table stored in memory of the latch controller 13, to determine the associated latch component position, and more broadly determine the latch state, such as locked state, unlocked state, released state, cinch state, overtravel state, secondary position state, primary position state for example.

The present disclosure provides a latch assembly for a closure of a vehicle. The latch assembly includes: a latch mechanism having a plurality of latch components, a non-contact sensor configured to detect a position of at least one target, and a sensor monitor circuit in functional communication with the non-contact sensor. Each of the latch components is movable to define a plurality of operating positions of the latch mechanism. The sensor monitor circuit is configured to determine a position of at least one latch component of the plurality of latch components based on the detected position of the at least one metal target.

In some embodiments, the plurality of latch components includes a lever having a body, and wherein the body of the lever defines the at least one metal target. In a possible configuration, the latch components is a lever having a metal body. Alternatively or additionally, the metal target may be another portion of a lever or another latch component and/or a part, such as a flag, attached thereto.

In some embodiments, the sensor monitor circuit is configured to make a Boolean determination regarding presence of metal within a given region associated with the non-contact sensor, for detecting the position of the at least one metal target. For example, the sensor monitor circuit may make an On/Off or Present/Not-present determination for each of the non-contact sensor, such as the determinations described above and shown in Tables 1-2.

In some embodiments, the non-contact sensor is an inductive proximity sensor having a transmitting coil and a receiving coil, and the inductive proximity sensor is operable to detect the at least one metal target within a given region adjacent thereto.

In some embodiments, the non-contact sensor may be a light field sensor, such as an infrared sensor, or a LED sensor that is configured to emit a wave that may be absorbed or may be reflected by the latch component in or out of the path of the light field, where such a reflection or absorption may be detected by the non-contact sensor.

In some embodiments, the non-contact sensor is one of a plurality of non-contact sensors each in functional communication with the sensor monitor circuit, and each non-contact sensor of the plurality of non-contact sensors is configured to detect a presence of a corresponding latch component of the plurality of latch components within a given region adjacent thereto.

In some embodiments, each non-contact sensor of the plurality of non-contact sensors includes a receiving coil, and the receiving coils of the plurality of non-contact sensors are connected in a daisy-chain to a common input terminal of the sensor monitor circuit.

In some embodiments, the sensor monitor circuit is configured to detect a voltage on the common input terminal and to thereby distinguish between a plurality of different possible arrangements of the plurality of latch components relative to the plurality of non-contact sensors. For example, the sensor monitor circuit may distinguish between the plurality of different possible arrangements of the plurality of latch components as described above and shown in Tables 1-2.

In some embodiments, each non-contact sensor of the plurality of non-contact sensors includes a receiving coil, the receiving coils of a set of the plurality of non-contact sensors are connected in a daisy-chain to a first common input terminal of the sensor monitor circuit, and the receiving coils of another set of the plurality of non-contact sensors are connected in a daisy-chain to a second common input terminal of the sensor monitor circuit. For example, the plurality of non-contact sensors may be arranged as shown on FIG. 3 and as described above.

In some embodiments, the latch assembly further includes a printed circuit board (PCB), and the sensor monitor circuit and the non-contact sensor are each disposed upon or formed within the printed circuit board. For example, the sensor monitor circuit may be formed, at least in part, by an integrated circuit mounted on the printed circuit board. Additionally or alternatively, one or more of the inductive position sensors may function as the non-contact sensor and may include two or more coils which may be implemented using conductive traces of the PCB.

In some embodiments, the printed circuit board extends in a plane overlying the plurality of latch components, and the sensor monitor circuit includes one or more coils defined by a conductor within the plane of the printed circuit board. For example, one or more of the inductive position sensors may function as the non-contact sensor and may include two or more coils which may be implemented using conductive traces of the PCB 126.

In some embodiments, the plurality of latch components includes at least one of: a release lever, a pawl, a cinch lever, a ratchet, and a power release gear. For example, the plurality of latch components may include one or more of: the release lever 73 of the latch release mechanism 54, the pawl 70, the cinch lever 53, the ratchet 60, and/or the power release gear 90. In some embodiments, the plurality of latch components includes each of: the release lever, the pawl, the cinch lever, the ratchet, and the power release gear.

In some embodiments, the non-contact sensor is one of a plurality of non-contact sensors each in functional communication with the sensor monitor circuit, and each non-contact sensor of the plurality of non-contact sensors is configured to detect a presence, or absence, of a corresponding latch component of the plurality of latch components within a given region adjacent thereto.

In some embodiments, the sensor monitor circuit is further configured to communicate, to a remote electronic control unit, a status of the latch assembly based on the position of the at least one latch component. For example, the sensor monitor circuit 130 may be configured to provide status feedback to the vehicle's Body Control Module (BCM) regarding a condition of the latch assembly which is defined by positions of one or more of the latch components. In some embodiments, the sensor monitor circuit is further configured to communicate, to an electronic control unit local to the latch assembly housing 40. In some embodiments, the sensor monitor circuit may be integrated into part of a latch controller 13. A latch controller 13 may consist of various hardware and software components that are integrated into the latch assembly 22. For example the latch controller 13 may be mounted onto the substrate 126, or on a separate printed circuit board housing within the latch assembly 22. Alternatively latch controller 13 may be remote. One example of a latch controller 13 local to the latch assembly 22 is shown and described in co-owned patent publication No. US20250327345A1, titled “Boosterless electronic latch circuit”, the entire contents of which are incorporated herein by reference.

In some embodiments, the sensor monitor circuit includes an integrated circuit defining an oscillator output terminal and an input terminal, and each of the oscillator output terminal and the input terminal of the sensor monitor circuit is connected to a corresponding coil of the non-contact sensor. For example, the sensor monitor circuit may be arranged as part of the sensing system 128 as shown on FIG. 3 and described above.

In some embodiments, the sensor monitor circuit may be associated with an actuator assembly associated with the latch assembly, such as a remote cinch actuator, a remote ice-breaking actuator, and a remote presenting actuator.

In some embodiments, the sensor monitor circuit may be associated with a power side door actuator for moving a closure relative to a vehicle body between an open position and a closed position.

In some embodiments, the sensor monitor circuit may be associated with an window regulator assembly associated for moving a window panel relative to a vehicle door between an open position and a closed position.

The present disclosure also provides a vehicle that includes the subject latch assembly. In some embodiments, the closure is a passenger door of the vehicle. However, the subject latch assembly may have other applications, such as for a tailgate or liftgate or hood or frunk of a motor vehicle.

The present disclosure also provides a latch assembly for a closure of a vehicle and which includes: a latch mechanism having a plurality of latch components, and a sensor monitor circuit in functional communication with a non-contact sensor. The plurality of latch components are each movable to define a plurality of operating positions of the latch mechanism. The plurality of latch components includes a release lever having a body of metal. The non-contact sensor is configured to detect the body of the release lever within a given region adjacent to the non-contact sensor.

In some embodiments, the non-contact sensor is one of a plurality of non-contact sensors each in functional communication with the sensor monitor circuit, and each non-contact sensor of the plurality of non-contact sensors is configured to detect a presence of a corresponding latch component of the plurality of latch components within a corresponding region adjacent thereto.

In some embodiments, the latch assembly further includes a printed circuit board, the sensor monitor circuit and the non-contact sensor are each disposed upon or formed within the printed circuit board, and the printed circuit board extends in a plane overlying the plurality of latch components, and wherein the sensor monitor circuit includes one or more coils defined by a conductor within the plane of the printed circuit board.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A latch assembly for a closure of a vehicle, comprising:
a latch mechanism having at least one latch component each being movable to an operating position;
a non-contact sensor arrangement configured to detect the presence of the at least one latch component relative to a given region adjacent thereto; and
a sensor monitor circuit in functional communication with the non-contact sensor arrangement and configured to determine a position of the at least one latch component based on the detected presence.

2. The latch assembly of claim 1, wherein the non-contact sensor arrangement is configured to detect a metal portion of the at least one latch component.

3. The latch assembly of claim 2, wherein the at least one latch component includes a body, and wherein the body is formed from metal to define the metal portion.

4. The latch assembly of claim 2, wherein the non-contact sensor arrangement is not configured to detect a magnet mounted on the at least one of latch component.

5. The latch assembly of claim 1, wherein the non-contact sensor arrangement comprises at least one non-contact sensor each configured to generate a field into the given region to detect the presence of the at least one latch component, wherein each non-contact sensor is configured to detect a disturbance of the field due to the at least one of latch component interacting with the field.

6. The latch assembly of claim 5, wherein the at least one non-contact sensor comprises a plurality of non-contact sensors in electrical communication with the sensor monitor circuit, wherein the plurality of non-contact sensors are coupled with each other in a sequence.

7. The latch assembly of claim 6, wherein one of the non-contact sensors defines a first non-contact sensor of the sequence and another one of the non-contact sensors defines a last non-contact sensor of the sequence.

8. The latch assembly of claim 7, wherein the sensor monitor circuit is adapted to apply an excitation signal to the sensor arrangement to cause each non-contact sensor to generate the field.

9. The latch assembly of claim 8, wherein each non-contact sensor comprises an input node and an output node, wherein at least one non-contact sensor has its input node that is coupled with the output node of another non-contact sensor, and wherein at least one non-contact sensor has its input node connected to the sensor monitor circuit to receive the excitation signal.

10. The latch assembly of claim 9, wherein the excitation signal is an alternating signal.

11. The latch assembly of claim 10, wherein the output node of the last non-contact sensor of the sequence is connected to a voltage bias.

12. The latch assembly of claim 7, wherein each non-contact sensor has a first coil configured to generate the field in response to receiving the excitation signal, wherein the non-contact sensor arrangement comprises a first circuit interconnecting a plurality of the first coils together in a series arrangement.

13. The latch assembly of claim 12, wherein each non-contact sensor has a second coil configured to generate a current in response to being subjected to the generated field that is modified by the at least one of latch component interacting with the generating field, wherein the non-contact sensor arrangement comprises a second circuit interconnecting a plurality of the second coils together in a series arrangement.

14. The latch assembly of claim 13, wherein the sensor monitor circuit is configured to detect a voltage level of the second circuit that is generated by the plurality of second coils to thereby distinguish between a plurality of different possible positions of the at least one latch component relative to the plurality of non-contact sensors.

15. The latch assembly of claim 1, further including a printed circuit board, wherein the sensor monitor circuit and the sensor arrangement are each disposed upon or formed within the printed circuit board.

16. The latch assembly of claim 15,
wherein each non-contact sensor has a first coil configured to generate a field in response to receiving the excitation signal from the sensor monitor circuit, wherein the non-contact sensor arrangement comprises a first circuit interconnecting a plurality of the first coils together in a series arrangement;
wherein each non-contact sensor has a second coil configured to generate a current in response to being subjected to the generated field that is modified by the at least one of latch component interacting with the generated field, wherein the non-contact sensor arrangement comprises a second circuit interconnecting a plurality of the second coils together in a series arrangement;
wherein the printed circuit board includes a first side, and a second opposite side, wherein the first circuit is printed on the first side and the second circuit is printed on the second side.

17. The latch assembly of claim 15, wherein the printed circuit board extends in a plane overlying the plurality of latch components, and wherein the sensor monitor circuit includes one or more coils defined by a conductor within the plane of the printed circuit board.

18. The latch assembly of claim 1, wherein the plurality of latch components includes at least one of: a release lever, a pawl, a cinch lever, a ratchet, and a power release gear.

19. The latch assembly of claim 1, wherein the sensor monitor circuit is further configured to communicate, to a latch controller, a status of the latch assembly based on the determined position of the at least one latch component.

20. The latch assembly of claim 1, wherein the closure is a passenger door of the vehicle.
